(19) United States
(12) Patent Application Publication
(10) Pub. No.: US 2019/0135077 A1
(43) Pub. Date: May 9, 2019

(54) PLANAR HEATER AND MANUFACTURING METHOD THEREOF

(71) Applicant: SEOYON E-HWA CO., LTD., Seoul (KR)

(72) Inventors: Si Wook LEE, Seoul (KR); Dong Suk KIM, Ansan-si (KR); Hyung Won PARK, Ansan-si (KR); Seok Hwan HONG, Cheonan-si (KR)

(73) Assignee: SEOYON E-HWA CO., LTD., Seoul (KR)

(21) Appl. No.: 16/180,253

(22) Filed: Nov. 5, 2018

(30) Foreign Application Priority Data
Nov. 6, 2017 (KR) 10-2017-0146390

(51) Int. Cl. B60H 1/22; H05B 3/14; H05B 3/34

(52) U.S. Cl. CPC B60H 1/2218; H05B 3/145; B60H 2001/2293; H05B 2203/017; H05B 2203/015; H05B 3/347

(57) ABSTRACT

A planar heater includes: a body forming a car interior material, having an upper side opened, and having an accommodation space formed therein; a planar heating portion installed on an upper side of the body; and a foam layer foaming between the body and the planar heating portion and installed in the accommodation space.

### CROSS-REFERENCE TO RELATED APPLICATION(S) AND CLAIM OF PRIORITY

The present application claims the benefit under 35 U.S.C. § 119(a) to a Korean patent application filed in the Korean Intellectual Property Office on Nov. 6, 2017, and assigned Serial No. 10-2017-0146390, the entire disclosure of which is hereby incorporated by reference.

### TECHNICAL FIELD OF THE INVENTION

The present disclosure relates generally to a planar heater and a manufacturing method thereof, and more particularly, to a planar heater which can be applied to car interior materials, and a manufacturing method thereof.

### BACKGROUND OF THE INVENTION

Interior materials of cars include various commodities such as a door trim, a bumper, a console, a sheet, etc.

Related-art cars were just regarded as means of transport, and aesthetic aspects, tactility, and various functions (for example, a heating function) of car interior materials were not taken into great consideration.

However, modern cars are regarded as commodities representing users' personalities as well as means of transport, and many researches for enhancing car interior materials are being conducted.

With this trend, car interior materials are enhanced to satisfy users' desired functions and emotional quality. In particular, the door trim among the car interior materials enhances the aesthetic aspect of car interiors, and also, provides a driver and a passenger with a comfortable, pleasant space, protects the driver and the passenger from external shocks while driving, and serves as a storage space and an installation space for safety equipment, electronic equipment, etc. In addition, since users' arms or legs may be adjacent to the door trim, users' satisfaction can be enhanced if a heating function is added to the door trim.

However, if a related-art heater is simply installed, it may be difficult to install the heater in a curved door trim, and also, there are problems that an installation structure is complicated and the heater is not fixedly installed.

### SUMMARY OF THE INVENTION

To address the above-discussed deficiencies of the prior art, it is a primary object of the present disclosure to provide a planar heater stably installed in a car interior material, and a manufacturing method thereof.

According to a first aspect of the present disclosure to achieve the above-described object, a planar heater includes: a body forming a car interior material, having an upper side opened, and having an accommodation space formed therein; a planar heating portion installed on an upper side of the body; and a foam layer foaming between the body and the planar heating portion and installed in the accommodation space.

The planar heating portion may include: fiber threads woven by weft and warp; heating threads inserted into the weft or warp of the fiber threads at regular interval, and woven; and metal leading wires woven at left and right sides of the fiber threads and configured to supply power to the heating threads.

In addition, the heating threads may be formed by carbon fiber.

In addition, the metal leading wires may be woven with the fiber threads in a zigzag pattern.

According to an embodiment, polyurethane may foam to form the foam layer.

Herein, a portion of the foam layer may foam while passing through the planar heating portion, and may allow the planar heating portion to be impregnated with the foam layer.

According to the present embodiment, a skin layer may be arranged on an upper side of the foam layer.

In addition, the planar heater may further include: a sensor unit configured to measure temperature of the planar heating portion; and a temperature controller configured to control the temperature of the planar heating portion.

According to a second aspect of the present disclosure, a method for manufacturing a planar heater includes: injection-molding a body forming a car interior material, having an upper side opened, and having an accommodation space formed therein; inserting a planar heating portion into one side of a mold; seating the body in the other side of the mold such that the planar heating portion is positioned in the accommodation space of the body; and forming a foam layer by foaming in the accommodation space of the body.

In the present embodiment, in the step of forming the foam layer, a portion of the foam layer may foam while passing through the planar heating portion, and may allow the planar heating portion to be impregnated with the foam layer.

According to an embodiment, the method may further include coating a surface of the foam layer with an adhesive, and encapsulating the foam layer with a skin layer.

According to the present disclosure, the planar heating portion is configured to be impregnated with the foam layer, such that the planar heater can be stably installed in a car interior material formed of curved surfaces.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a planar heating portion included in a planar heater according to an embodiment of the present disclosure;

FIGS. 2 and 3 are views illustrating an insertion step and a foaming step in a planar heater manufacturing method according to an embodiment of the present disclosure;

FIGS. 4 and 5 are views illustrating a skin layer encapsulation step in the planar heater manufacturing method according to an embodiment of the present disclosure;

FIG. 6 is a view illustrating a step of seating an injection-molded product in a mold in the planar heater manufacturing method according to an embodiment of the present disclosure;

FIG. 7 is a view illustrating a step of fixing a planar heating portion to the mold in the planar heater manufacturing method according to an embodiment of the present disclosure;

FIG. 8 is a view illustrating a state in which foaming is completed in the planar heater manufacturing method according to an embodiment of the present disclosure;

FIG. 9 is a view illustrating a front portion of the planar heater after the skin layer encapsulation step is completed in the planar heater manufacturing method according to an embodiment of the present disclosure; and

FIG. 10 is a view illustrating a rear portion of the planar heater after the skin layer encapsulation is completed in the planar heater manufacturing method according to an embodiment of the present disclosure.

### DETAILED DESCRIPTION OF THE INVENTION

Hereinafter, embodiments of the present disclosure will be described in more detail with reference to the accompanying drawings. In the following description, same reference numerals are used for the same elements when they are depicted in different drawings. In the description of embodiments, certain detailed explanations of well-known components or functions are omitted when it is deemed that they may unnecessarily obscure the essence of the present disclosure. In addition, exemplary embodiments of the present disclosure will now be described, but the technical idea of the present disclosure is not limited thereto and various changes can be made by a person skilled in the art and other equivalents embodiments are possible.

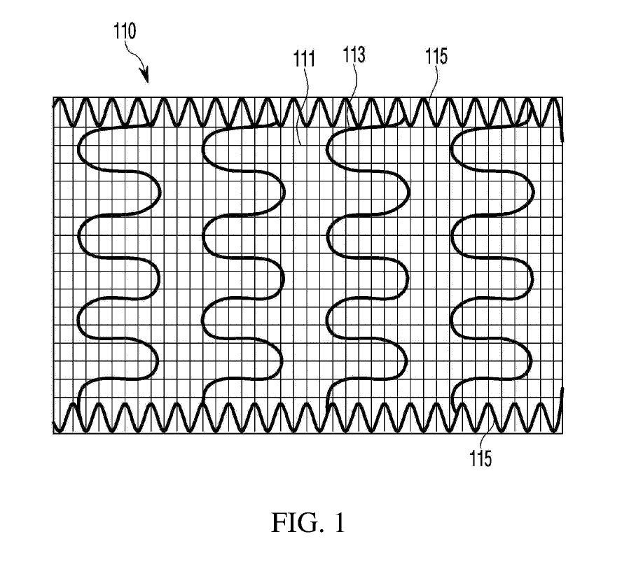

FIG. 1 is a view illustrating a planar heating portion included in a planer heater according to an embodiment of the present disclosure.

As shown in FIG. 1, the planar heating portion 110 included in the planar heater according to an embodiment is configured to have flexibility such that the planar heating portion 110 can be installed in a car interior material having a curved surface.

In the embodiment of FIG. 1, the planar heating portion 110 has a basic structure which is formed of fiber threads 111 woven by weft and warp.

In addition, heating threads 113 which emit heat when power is supplied are inserted into the weft or warp of the fiber threads 111 at regular intervals, and are woven, and are configured to uniformly emit heat.

Herein, the heating threads 113 may be formed by using various heating materials, but in the present embodiment, is formed by carbon fiber.

The carbon fiber is flexible compared to other heating materials such as metal heating wires, and is resistant to a load or a repeated shock, and thus has excellent durability. Therefore, the carbon fiber is desirable to be applied to car interior materials having curved surfaces.

The planar heating portion 110 has metal leading wires 115 installed therein to be connected to the heating threads 113 to supply power to the heating threads 113.

The metal leading wires 115 are woven with the left and right sides of the fiber threads 111, and are connected to a positive (+) electrode and a negative (−) electrode and are configured to supply power.

Herein, the metal leading wires 115 are woven with the fiber threads 111 in a zigzag pattern, and thus may be more securely coupled to the fiber threads 111, and may be in contact with the heating threads 113 at more portions and may be configured to smoothly supply power.

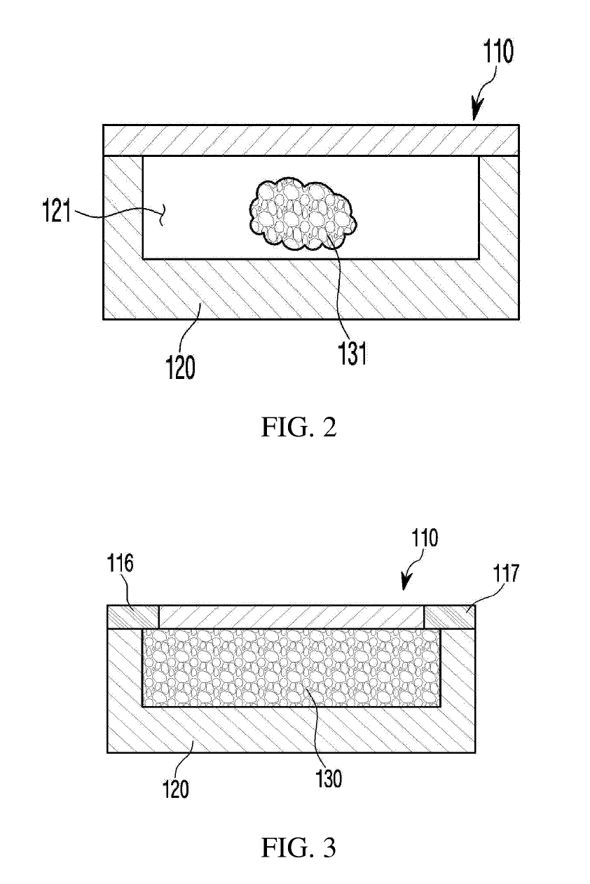

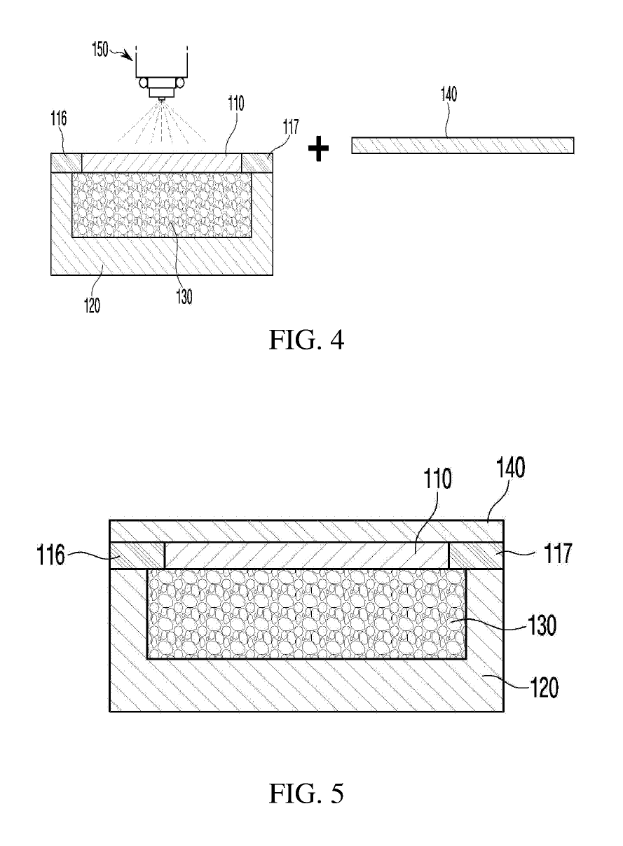

FIGS. 2 and 3 are views illustrating an insertion step and a foaming step in a planar heater manufacturing method according to an embodiment, FIG. 4 is a view illustrating a skin layer encapsulation step in the planar heater manufacturing method according to an embodiment, and FIG. 5 is a view illustrating the planar heater according to an embodiment.

Referring to FIG. 2, in the insertion step of the planar heater manufacturing method according to an embodiment, a body 120 is prepared and the planar heating portion 110 is arranged on an upper side of the body 120.

Herein, the body 120 is an injection-molded product which is manufactured by injection molding, and forms a car interior material, and has an upper side opened and has an accommodation space 121 formed therein.

In an embodiment, a foaming solution 131 for foaming is prepared between the body 120 and the planar heating portion 110, that is, in the accommodation space 121 of the body 120 located under the planar heating portion 110.

Herein, the foaming solution 131 may use various kinds of foaming solutions, but, in the present embodiment, polyurethane which may form a car interior material, and may be formed in the form of a sponge after foaming, and provides a good cushioning effect and has an excellent heat insulation property may be used.

Referring to FIG. 3, in the foaming step of the planar heater manufacturing method according to an embodiment, the foaming solution 131 foams, thereby forming a foam layer 130 to fill the accommodation space 121 of the body 121.

Herein, as shown in FIG. 3, the foam layer 130 may be formed only under the planar heating portion 110, but the present disclosure is not limited thereto. For example, a portion of the foam layer 130 may foam while passing through the planar heating portion 110, such that the planar heating portion 110 is impregnated with the foam layer 130.

In the embodiment as described above, the planar heating portion 110 is securely fixed to the body 120 by the foam layer 130.

In particular, since the planar heating portion 110 is formed of the fiber threads 111 woven, a plurality of pores are formed between the fiber threads 111 and allow the foam layer 130 to permeate therethrough. When the foam layer 130 passes through the pores of the planar heating portion 110 and the planar heating portion 110 is impregnated with the foam layer 130, the planar heating portion 110 in the foam layer 130 is more stably fixed.

In addition, since the planar heating portion 110 according to an embodiment is impregnated with the foam layer 130 and is fixed, the planar heating portion 110 may be elastically deformed along with the foam layer 130 when a user touches, and thereby can perform a heating function while maintaining softness.

As shown in FIGS. 2 and 3, a positive (+) terminal 116 and a negative (−) terminal 117 are provided at both ends of the planar heating portion 120, and are connected to the metal leading wires 115 shown in FIG. 1, and are configured to supply power.

As shown in FIG. 4, in the skin layer encapsulation step of the planar heater manufacturing method according to an embodiment, an adhesive is sprayed and coated on the upper surface of the planar heating portion 110 (or the foam layer 130 when the planar heating portion 110 is impregnated) by an adhesive spraying unit 150, with the planar heating portion 110 being securely fixed to the body 120 by the foam layer 130, and a skin layer 140 for encapsulating is prepared.

Herein, artificial leather or genuine leather may be used for the skin layer 140 to enhance user's sense of touch.

After that, as shown in FIG. 5, when the skin layer 140 is bonded to the upper surface of the planar heating portion 110 (or the foam layer 130 when the planar hating portion 110 is impregnated), and encapsulation is completed, the planar heater of the present disclosure is completed.

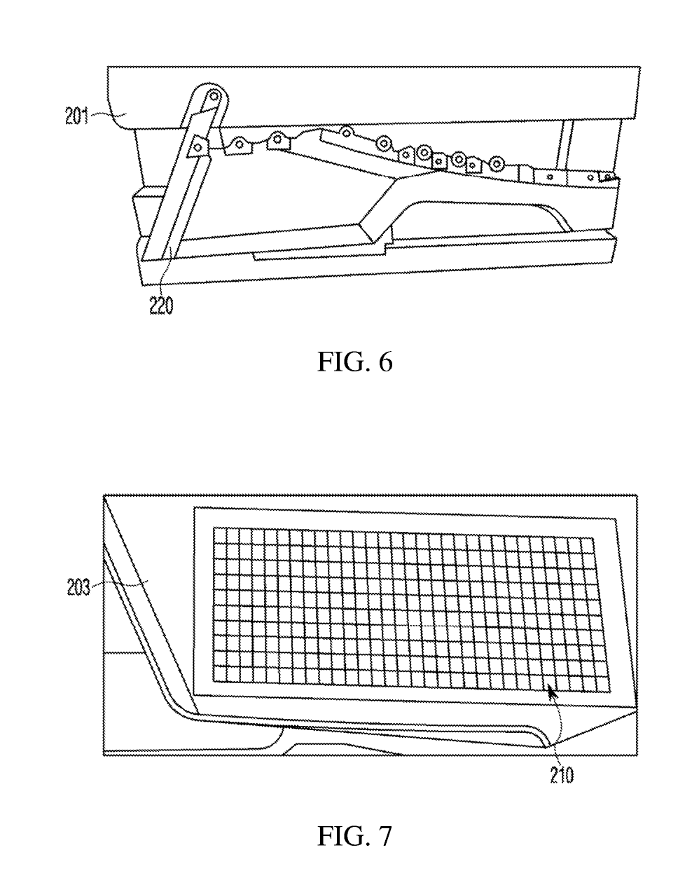

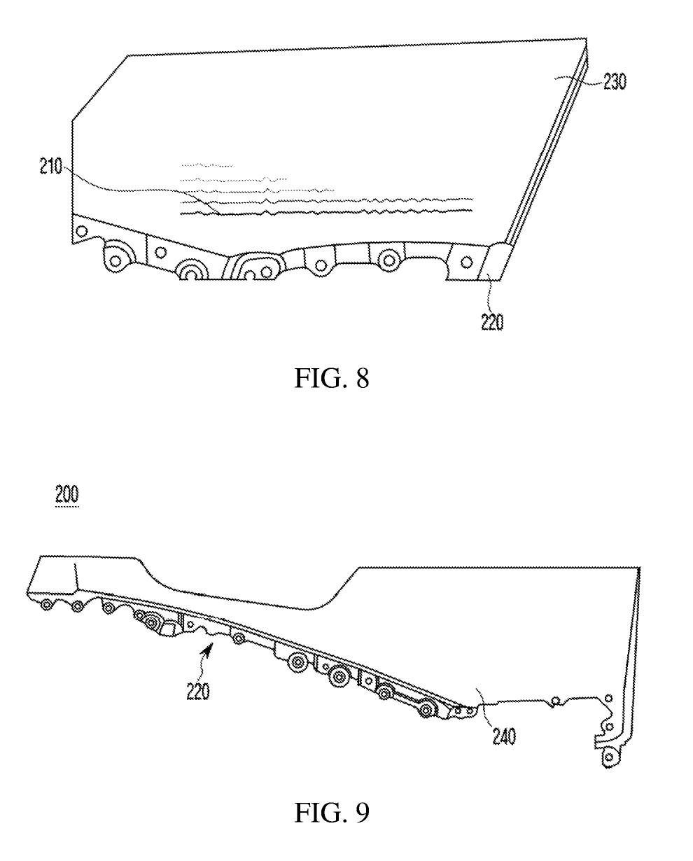

FIG. 6 is a view illustrating a step of seating an injection-molded product in a mold in the planar heater manufacturing method according to an embodiment, FIG. 7 is a view illustrating a step of fixing a planar heating portion to the mold in the planar heater manufacturing method according to an embodiment, and FIG. 8 is a view illustrating a state in which foaming is completed in the planar heater manufacturing method according to an embodiment of the present disclosure;

In FIGS. 6 to 8, an injection process in the planar heater manufacturing method according to the present embodiment will be described.

Referring to FIG. 6, a body 220 forming a car interior material is seated in a first mold 201.

In addition, as shown in FIG. 7, a planar heating portion 210 is inserted into a second mold 203.

Herein, the body 220 has an upper side opened and has an accommodation space formed therein, and the body 220 is seated in the first mold 201 and the planar heating portion 210 is placed in the second mold 230, such that the planar heating portion 210 is positioned in the accommodation space of the body 220.

Thereafter, foaming is performed with the first mold 201 and the second mold 203 being closed, and a foam layer 230 is formed in the body 220 and the planar heating portion 210 is impregnated with the foam layer 230.

Thereafter, an adhesive is coated on the upper surface of the foam layer 230 as shown in FIGS. 4 and 5, and an encapsulation process is performed.

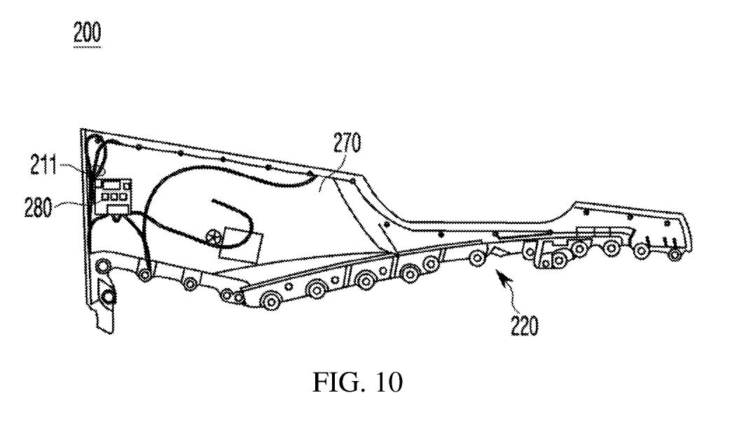

FIG. 9 is a view illustrating a front portion of the planar heater after the skin layer encapsulation step is completed in the planar heater manufacturing method according to an embodiment, and FIG. 10 is a view illustrating a rear portion of the planar heater after the skin layer encapsulation is completed in the planar heater manufacturing method according to an embodiment.

As shown in FIG. 9, the front portion of the planar heater 200 is embedded in the body 220 as the skin layer 240 covers the foam layer 230.

As shown in FIG. 10, a sensor unit 270 for measuring temperature of the planer heating portion (not shown), and a temperature controller 280 for controlling temperature of the planar heating portion (not shown) are provided on the rear portion of the planar heater 200, and are configured to control temperature of the planar heating portion (not shown) according to temperature set by a user.

Herein, the sensor unit 270 may be configured to measure temperature of the planar heating portion (not shown) as in the above-described embodiment, but may be configured to measure indoor temperature of a car, and to cause the planar heating portion (not shown) to emit heat to automatically reach temperature set by the user according to indoor temperature.

A terminal 211 is connected with the metal leading wires (not shown) of the planar heating portion (not shown), and is configured to be able to supply power.

According to an embodiment as described above, the planar heater can be manufactured to have the planar heating portion fixed to the body by the foam layer, and thus to allow a car interior material having a heating function to have a more simple and more secure structure.

In addition, the planar heating portion is made of carbon fiber and thus enhances flexibility and durability, and can be mounted in a car interior material having curved surfaces. In addition, since the foam layer and the planar heating portion are combined with each other, softness of the foam layer can be maintained.

While preferred embodiments of the present disclosure have been illustrated and described, the present disclosure is not limited to the above-described specific embodiments. Various modifications, changes, or substitutions can be made by a person skilled in the art without departing from the scope of the present disclosure. Therefore, the embodiments disclosed in the present disclosure and the accompanied drawings are not intended to limit the technical idea of the present disclosure, and the scope of the technical idea of the present disclosure is not limited by the embodiments and the accompanied drawings. The scope of the technical protection of the present disclosure should be defined by the technical concept of the appended claims, and all technical ideas belonging to the same scope should be interpreted as being included in the scope of the protection of the present disclosure.

What is claimed is:

1. A planar heater comprising:
a body forming a car interior material, having an upper side opened, and having an accommodation space formed therein;
a planar heating portion installed on an upper side of the body; and
a foam layer foaming between the body and the planar heating portion and installed in the accommodation space.

2. The planar heater of claim 1, wherein the planar heating portion comprises:
fiber threads woven by weft and warp;
heating threads inserted into the weft or warp of the fiber threads at regular interval, and woven; and
metal leading wires woven at left and right sides of the fiber threads and configured to supply power to the heating threads.

3. The planar heater of claim 2, wherein the heating threads are formed by carbon fiber.

4. The planar heater of claim 2, wherein the metal leading wires are woven with the fiber threads in a zigzag pattern.

5. The planar heater of claim 1, wherein polyurethane foams to form the foam layer.

6. The planar heater of claim 5, wherein a portion of the foam layer foams while passing through the planar heating portion, and allows the planar heating portion to be impregnated with the foam layer.

7. The planar heater of claim 1, wherein a skin layer is arranged on an upper side of the foam layer.

8. The planar heater of claim 2, further comprising:
a sensor unit configured to measure temperature of the planar heating portion; and
a temperature controller configured to control the temperature of the planar heating portion.

9. A method for manufacturing a planar heater, the method comprising:
injection-molding a body forming a car interior material, having an upper side opened, and having an accommodation space formed therein;
inserting a planar heating portion into one side of a mold;
seating the body in the other side of the mold such that the planar heating portion is positioned in the accommodation space of the body; and
forming a foam layer by foaming in the accommodation space of the body.

10. The method of claim 9, wherein, in the step of forming the foam layer, a portion of the foam layer foams while passing through the planar heating portion, and allows the planar heating portion to be impregnated with the foam layer.

11. The method of claim 10, wherein, in the step of forming the foam layer, polyurethane foams to form the foam layer.

12. The method of claim 11, further comprising coating a surface of the foam layer with an adhesive, and encapsulating the foam layer with a skin layer.
